(19) United States
(12) Patent Application Publication
(10) Pub. No.: US 2008/0072248 A1
(43) Pub. Date: Mar. 20, 2008

(54) Method of marketing diposable consumer products in conjunction with a motion picture

(75) Inventors: Paula M. Sosalla, Appleton, WI (US); Kellie M. Goodrich, Appleton, WI (US); Shannon K. Melius, Appleton, WI (US)

Correspondence Address: KIMBERLY-CLARK WORLDWIDE, INC.;Catherine E. Wolf, 401 NORTH LAKE STREET, NEENAH, WI, 54956, US

(73) Assignee: Kimberly-Clark Worldwide, Inc.

(21) Appl. No.: 11/512,797

(22) Filed: Aug. 29, 2006

(51) Int. Cl. H04N 7/025; H04N 5/445; H04N 7/10; G06F 3/00; G06F 13/00; H04N 7/16

(52) U.S. Cl. 725/34; 725/35; 725/135; 725/42

(57) ABSTRACT

A method of marketing a motion picture in conjunction with a disposable consumer product. A marketing vehicle is created by directly associated a motion picture identifier with an item to create a primary, secondary, or tertiary marketing vehicle. Any combination of primary, secondary, or tertiary marketing vehicles are sold to shoppers, choosers, and/or users prior to the motion-picture release date to achieve a desired marketing effect.

### FIELD OF THE INVENTION

The present invention relates to a business method for marketing of disposable consumer goods, and in particular, to a method of marketing disposable consumer products such as diapers, training pants, swim pants, and the like, in conjunction with a motion picture.

### BACKGROUND

Hollywood and fast food have been closely aligned since the 1980s, with some sort of fast-food tie-in to almost every major film targeting children. However, some movie makers are rethinking this type of marketing. For example, after 2006, Disney is not renewing its cross-promotional contracts with the fast-food giant McDonalds, ending the arrangement. One reason for non-renewal is that a company such as Disney, which prides itself on being family friendly, wants to distance itself from fast food and its links to the epidemic of childhood obesity.

As many as 40% of young children are overweight, and about 20% fall into the obese category. Very few of these kids are going to grow out of it. Statistics show that most overweight children are going to grow up to be overweight and obese adults.

In response to the growing problem of childhood obesity, a National Academy of Sciences panel has released a study showing how food marketing adversely affects children's diets. The committee thought it was important for the use of motion picture characters that appeal to children only to be used in the marketing of healthy products.

Because fast food has been an important promotional partner in promoting films to children, motion picture makers will need to be more creative in reaching children through other promotional outlets. Being a promotional effort, such marketing efforts preferably take place prior to the release date of the promoted film. As such, there exists a need for marketing healthy products in conjunction with movies directed to children at a time prior to the film release date. Moreover, movie makers will also need to be more aggressive in marketing efforts. Therefore, there exists a need to expand marketing efforts to a wider audience in a cost effective manner, such as toward the caretakers of children younger than about 3 years of age (the youngest age typically targeted for co-promotion of fast food and motion pictures).

### SUMMARY

One aspect of the present invention includes a marketing method comprising the steps of: identifying a motion-picture having a future release date, disposing a motion-picture identifier that identifies the motion picture directly on a disposable health and hygiene article to create a first marketing vehicle, combining the first marketing vehicle with a second marketing vehicle to create a promotional vehicle, and offering the promotional vehicle for sale prior to the motion-picture release date.

Another aspect of the present invention includes a marketing method comprising the steps of: identifying a motion-picture having a future release date, disposing a motion-picture identifier that identifies the motion picture directly on a disposable absorbent article to create a first marketing vehicle, combining the first marketing vehicle with a second marketing vehicle to create a promotional vehicle, and offering the promotional vehicle for sale at least 1 month prior to the motion-picture release date.

Yet another aspect of the present invention includes a marketing method comprising: identifying a motion-picture having a release date, disposing a motion-picture identifier that identifies the motion picture directly on a disposable consumer product to create a promotional vehicle, and offering the promotional vehicle for sale prior to the release date. The promotional vehicle has at least two degrees of marketing effect.

### BRIEF DESCRIPTION OF THE DRAWINGS

FIG. 1 representatively illustrates a side view of a disposable diaper with a fastening member of the diaper in a fastened configuration;

FIG. 2 representatively illustrates a plan view of the diaper similar to that of FIG. 1 in an unfastened, stretched and laid flat condition, and showing the surface of the diaper that faces the wearer with portions cut away to show underlying features;

FIG. 3 representatively illustrates a perspective view of a package of diapers used as marketing vehicles in accordance with the present invention, with portions of the package cut away to show the diapers therein.

Corresponding reference characters indicate corresponding parts throughout the drawings.

### DETAILED DESCRIPTION

Generally, the present invention avoids the problems associated with prior business methods of co-promoting a motion picture with consumer goods or services by associating the motion picture with a disposable good. Disposable health and hygiene articles are not associated with food, and thus, are not prone to cause food cravings and/or poor eating habits. A shopper or chooser may be pleased that the purchase is going toward an item that promotes good health and hygiene instead of childhood obesity.

Within the context of this specification, each term or phrase below includes the following meaning or meanings:

“Disposable” refers to articles which are designed to be discarded after a limited use rather than being laundered or otherwise restored for reuse.

The term “disposable consumer product” is intended to mean a good or goods that form the basis for a sale to a shopper, user, or chooser. As an example, a diaper is a disposable consumer product, but the disposable packaging in which the diaper is packaged is not a disposable consumer product within the context of this invention. While the packaging is disposable, the consumer of the packaging is the manufacturer that uses it to package diapers, not the end user of the diapers.

The term “disposed directly on,” and variations thereof is intended to mean that one element associated with an item can be integral with another element, or that one element can be a separate structure bonded to or printed on another element.

The term “graphic” and variations thereof is intended to include any object, character, icon, or text. Motion-picture related graphics may be used to identify a character, story line, or object related to the motion picture being promoted.

The term “release date” refers to: (1) the date on which a motion picture is released to the general public in multiple theater locations for viewing and ticket sales, (2) the date on which a motion picture is released to multiple television broadcasters for showing regardless of a viewer purchase cost, and (3) the date on which a motion picture is released to the general public by DVD or video. Under this definition, private screenings or sneak previews of a motion picture before limited audiences take place prior to the release date.

The term “marketing vehicle” generally refers to the various types of separate motion picture promotional pieces or identifiers that may be used in conjunction with a disposable consumer product, including but not limited to: a motion-picture-related toy, an information piece related to the motion picture, a product bearing a motion-picture-related graphic, a product package bearing a motion-picture-related graphic, coupons, and the like. A component or item such as a bag, product, coupon, toy, and the like, are separate “vehicles.” When vehicles bear graphics related to a motion-picture, or are otherwise configured to relate to characters or other identifying features of a motion-picture story, they become “marketing vehicles.”

The term “promotional vehicle” generally refers to a good having one or more marketing vehicles included in the sale of the good to a shopper, chooser, or user. For example, a good having a motion-picture related graphic directly related thereon and combined with a movie trailer (or a link to downloading a movie trailer) is a promotional vehicle with two marketing vehicles.

The terms “single marketing effect,” “double marketing effect,” and “triple marketing effect” refer to the number of marketing vehicles combined with a disposable consumer product intended for a single sale. For example, a diaper having a motion-picture related graphic disposed directly thereon and packaged in a bag bearing the same or related motion-picture related graphic has a double marketing effect because consumers are exposed to two marketing vehicles; the bag and the product.

A motion picture that is promoted in accordance with the present invention may be any type of genre, have any type of rating, and may be animated or non-animated. A motion picture promoted in conjunction with a disposable consumer product may be directed toward either a user, shopper, or chooser of the disposable consumer product. For example, a disposable diaper may be promoted in conjunction with a motion picture suitable for the wearer to view and/or may be suitable for a chooser or shopper to view. The chooser and shopper of the disposable consumer product need not be the same person. For instance, in the diaper example, the chooser may be an older sibling, and the shopper may be a caregiver such as a parent. Such an example is not meant to limit the scope of the present invention.

The motion picture may be based on an new story or premier production, a sequel to a known story, or a new version of an old story from a book or screen play. Any motion picture may be marketed long before the release date to raise public awareness and generate excitement. However, it may be especially beneficial to market motion pictures based on a new story or a sequel farther in advance of a release date than a new version of an old story.

The motion picture may be marketed in conjunction with disposable consumer product(s) after movie trailers have been released to the general public. In this way, sales of the disposable consumer products may be driven by excitement generated by the future release of the motion picture. In the alternative, disposable consumer products may be merely advertised together with a motion picture before the release date of the motion picture and availability of the disposable consumer product in stores.

Movie trailers and movie posters are commonly used to market motion pictures in advance of and after release dates. Movie trailers are typically shown in theaters, television, computer games, internet, DVD and video, and the like. Movie posters may be seen in magazines, books, theaters, or other venues. Regardless of the type of story on which a motion picture is based, the promotion of a motion picture by movie trailer/poster may begin anywhere from about 1 week to about 18 months in advance of the corresponding release date. Likewise, a disposable consumer product such as a disposable absorbent article may be marketed in conjunction with the motion picture anywhere from about 1 week to about 18 months in advance of the corresponding release date. The movie trailer, movie poster, other movie promotional item may further include copy or video used to promote the disposable consumer good or other non-motion-picture related goods or services.

In one embodiment of the present invention, the co-marketing of a motion picture and a disposable consumer product is started at least 1 week before the release date of a movie. In another embodiment of the present invention, the co-marketing of a motion picture and a disposable consumer product is started at least 1 month before the release date of a motion picture. In another embodiment of the present invention, the co-marketing of a motion picture and a disposable consumer product is started at least 2 months before the release date of a motion picture. In another embodiment of the present invention, the co-marketing of a motion picture and a disposable consumer product is started at least 3 months before the release date of a motion picture. In another embodiment of the present invention, the co-marketing of a motion picture and a disposable consumer product is started at least 4 months before the release date of a motion picture. In another embodiment of the present invention, the co-marketing of a motion picture and a disposable consumer product is started at least 5 months before the release date of a motion picture. In yet another embodiment of the present invention, the co-marketing of a motion picture and a disposable consumer product is started at least 6 months before the release date of a motion picture. In even another embodiment of the present invention, the co-marketing of a motion picture and a disposable consumer product is started at least 9 months before the release date of a motion picture.

The degree of “marketing effect” is affected by the number of marketing vehicles used to promote a motion picture in conjunction with a disposable consumer product. For example, a package of wet wipes bearing motion picture graphics on the wipes packaging would have a single marketing effect for the motion picture. This is true regardless of how many separate graphics are located on the package (for example, motion picture graphics on the front and back of a single vehicle such as a box or bag would count as a single marketing vehicle). Of course, if there were also an inner package bearing motion picture graphics, there would then be a double marketing effect because the inner packaging would count as an additional vehicle. Likewise, a motion-picture-related toy added to the wipes packaging provides an additional degree of marketing effect because the toy is yet another vehicle used to market the motion picture.

Disposition of a graphic on a disposable consumer product may be achieved in two ways: first, by applying a graphic directly to the product; and second, by applying the graphic to an item auxiliary to the product, such as on packaging or the like. Marketing effect is dependent on motion-picture identifiers disposed on or configured with the disposable consumer product or auxiliary items provided with the disposable consumer product as part of the sale to a shopper, chooser, or user. Graphics may be easily applied to some products, e.g. diaper-type products. Graphics applied directly to a product can provide the advantage of added marketing effect without added cost to either the consumer, the motion picture company, or the company manufacturing the disposable consumer good (assuming graphics are already present on the good). Of course, graphics are impossible to dispose directly on most consumable products such as lotions, food, and the like.

The ability to place a marketing vehicle directly on a product positively influences the degree of marketing effect to advertising cost ratio. Put another way, the ability to use the disposable consumer product as a marketing vehicle would likely decrease the amount of money that must be spent to achieve a certain degree of market effect. For example, in a fast-food/motion-picture marketing campaign, the fast food is typically packaged in a container bearing motion picture graphics, and provided to the shopper, chooser, or user with a toy configured to be a marketing vehicle, such as an action figure or doll. The added toy means added advertising costs for the motion picture promotion. After all, the food is the product, not the toy. In contrast to the fast food example, when graphics are placed directly onto a product, the same double marketing effect may be achieved without inclusion of a toy and the costs associated therewith. For instance, diapers typically have graphics placed directly on the product. When compared to the addition of a separate marketing vehicle to the diaper sale, there is a relatively insignificant cost difference between different graphic designs on a diaper. Not only are the motion picture graphics on the product, they may be directly disposed on the packaging as well. The packaging may be an inherent part of a diaper purchase. Thus, in this example, a double marketing effect is achieved without the added cost of an additional toy, which is not an inherent part of a diaper purchase.

Primary and secondary marketing vehicles may be combined to co-promote a motion picture and a disposable consumer product. The primary marketing vehicle, a disposable consumer product, may have a graphic related to the motion picture disposed directly thereon. Secondary marketing vehicles may include: a toy bundled with the disposable consumer product, a coupon relating to the motion picture provided with the disposable consumer product, an informational piece relating to the motion picture combined with the disposable consumer product. One or more secondary marketing vehicles may be used with the primary marketing vehicle. In the alternative, one or more secondary marketing vehicles may by used in lieu of the primary marketing vehicle, as described below.

Tertiary marketing vehicles are defined as any disposable packaging that is used in conjunction with a primary or secondary marketing vehicle (e.g. packaging made from polymer film, nonwoven, paper, cloth, and the like). A durable package (a package meant to be reused several times or even washed occasionally) is considered a secondary marketing vehicle. For example, a cloth tote bag containing HUGGIES® brand disposable absorbent articles, wherein the bag and the articles have motion-picture graphics disposed directly thereon, includes a primary marketing vehicle (the HUGGIES® product) and a secondary marketing vehicle, the tote bag.

Referring now to Table 1, primary, secondary, and tertiary marketing vehicles may be used alone or in combination to achieve various degrees of marketing effect. Each marketing vehicle listed in Table 1 includes a motion-picture related identifier such as a graphic or configuration disposed directly thereon, or is configured or contains visual or audio files so that it relates to the motion picture. Each separate marketing vehicle may count as a single degree of marketing effect.

TABLE 1*

| | | |
|---|---|---|
| Marketing | Product/Item | |
| Vehicle Type | Categories | Example of product or item |

PRIMARY

| | |
|---|---|
| Disposable absorbent | Diapers; Swim pant; Incontinence garments; |
| article | Training pants, Bed pads, Changing pads, |
| | Bibs |
| Wet Wipes | For diaper changing, personal care, or |
| | hands/face |
| Mitts | Pre-applied with lotion, soap, insect repellent |
| | Plain |
| Sheets | Non-woven (e.g. NEAT SHEET, Kimberly |
| | Clark Corporation, Neenah, Wisconsin), |
| Clothing (disposable) | Underwear; Shirts; Shorts; Skirts; Socks; Hats, |
| | Outerwear, Shoes, Face masks, Gloves, |
| | Slacks, Swimwear, Bibs |
| Toilet paper, napkins, | Roll or sheet style |
| paper towels, facial | |
| tissue | |
| Sensors** | Ultraviolet radiation exposure sensor (such as |
| | a stick-on patch for application to skin or |
| | clothes); Wetness signaling transmitter or |
| | receiver (such as for diapers) |

SECONDARY

| | |
|---|---|
| Durable packaging | Tote bag; Backpack; Box; Purse, Doll house, |
| | Toy box, Diaper dispenser; |
| Toy | Action Figures/Figurine/Dolls; Inanimate |
| | objects (toy car, model object from movie); |
| | Games; Computer software; Puzzles; Books; |
| | Stickers |
| Audio files | CD, Tape, MP3 |
| Movie Trailer | DVD, Video, Podcast |
| Redeemable coupon | For movie ticket or theater, or additional |
| | marketing vehicles for same motion picture |
| Toiletry dispenser | For toilet paper, lotions, soaps, shampoos, wet |
| | wipes |
| Instructional Insert | Instructions for downloading or access to |
| | internet games, audio files, movie trailers, or |
| | coupons |
| Clothing (durable) | Underwear; Shirts; Shorts; Skirts; Socks; Hats, |
| | Outerwear, Shoes, Swimwear, Slacks |

TERTIARY

| | |
|---|---|
| Disposable packaging | Bags (plastic, nonwoven, paper, cloth); Boxes |
| | (corrugated, cardboard, plastic); Blister packs |

*See also U.S Patent Application 11/413474 filed Apr. 28, 2006, to Coulter et al. for further description of some of the goods listed herein, incorporated into this application to the extent that it is not in conflict with the present invention.
**See also U.S Patent Application 11/119377 filed Apr. 29, 2005, to Long; and U.S Patent Application 11/414031 filed Apr. 27, 2006, to Allen et al., incorporated into this application to the extent that it is not in conflict with the present invention.

Using Table 1 as a guideline, primary marketing vehicles may be sold alone or in combination with one another. In one embodiment, a secondary or tertiary marketing vehicle may be included in the sale of the primary marketing vehicle to achieve an additional degree of marketing effect. In another embodiment of the invention, additional secondary and/or tertiary marketing vehicles are added to the sale for yet another degree of marketing effect. There is no limit to the number of marketing effects that may be combined into a single sale of a primary marketing vehicle. In this case, such combinations may have at least one degree of marketing effect. In another embodiment of the invention, such combinations have at least two degrees of marketing effect. In another embodiment of the invention, such combinations have at least three degrees of marketing effect. In another embodiment of the invention, such combinations have at least four degrees of marketing effect. In yet another embodiment of the invention, such combinations have at least five degrees of marketing effect. In a further embodiment of the invention, such combinations have at least six embodiments of marketing effect. In even another embodiment of the invention, such combinations have at least seven degrees of marketing effect.

Again, using Table 1 as a guideline, a secondary marketing vehicle may be sold with other secondary marketing vehicles or tertiary marketing vehicles to achieve multiple marketing effects. Of course, these marketing vehicles may be combined with a non-marketing vehicle such as lotions, powders, shampoos, insect repellents, etc. In this case, such combinations may have at least three degrees of marketing effect. In another embodiment of the invention, such combinations have at least four degrees of marketing effect. In yet another embodiment of the invention, such combinations have at least five degrees of marketing effect. In a further embodiment of the invention, such combinations have at least six degrees of marketing effect. In even another embodiment of the invention, such combinations have at least seven degrees of marketing effect.

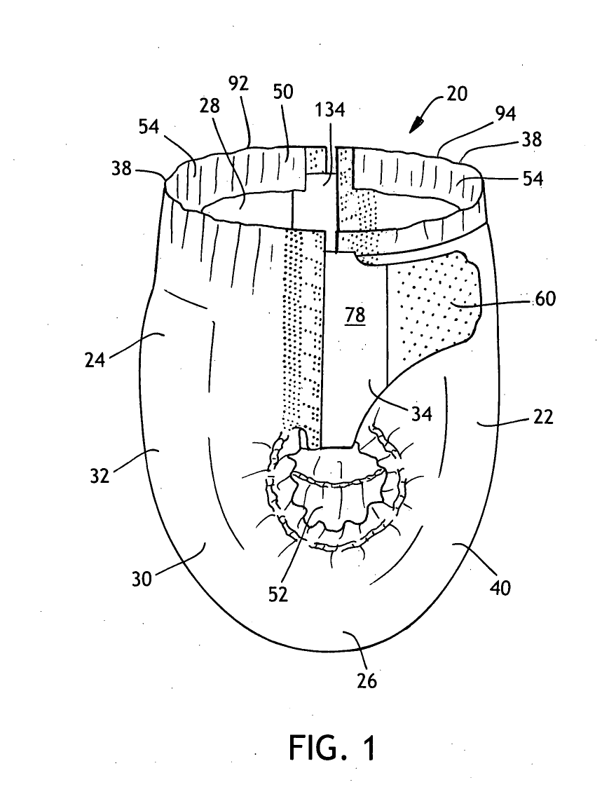

One example of a disposable consumer product that may be marketed in conjunction with the motion picture is a baby diaper. Referring now to the drawings and in particular to FIG. 1, an absorbent article of the present invention is representatively illustrated in the form of a baby diaper and is indicated in its entirety by the reference numeral 20. The diaper 20 can include a first ear 34 and a second ear 134. The diaper 20 can suitably be disposable, which refers to articles that are intended to be discarded after a limited period of use instead of being laundered or otherwise conditioned for reuse. It should also be understood that the present invention is suitable for use with various other absorbent articles intended for personal wear, including but not limited to children's training pants, feminine hygiene products, incontinence products, medical garments, surgical pads and bandages, other personal care or health care garments, and the like without departing from the scope of the present invention. The actual configuration of the diaper can vary widely, and this present example is not meant to limit the scope of the invention to this particular diaper configuration.

By way of illustration only, various materials and methods for constructing diapers such as the diapers 20 of the various aspects of the present invention are disclosed in U.S. patent application Ser. No. 11/281765, filed Nov. 16, 2005 in the name of Schields et al; U.S. patent application Ser. No. 10/836490, filed Apr. 29, 2004, in the name of Schlinz et al.; U.S. Pat. No. 5,496,298 issued Mar. 5, 1996, to Kuepper et al.; U.S. Pat. No. 4,798,603 issued Jan. 17, 1989, to Meyer et al.; U.S. Pat. No. 5,176,668 issued Jan. 5, 1993, to Bernardin; U.S. Pat. No. 5,192,606 issued Mar. 9, 1993, to Proxmire et al., and U.S. Pat. No. 5,509,915 issued Apr. 23, 1996, to Hanson et al., each of which are incorporated herein by reference to the extent that they are consistent (i.e., not in conflict) herewith.

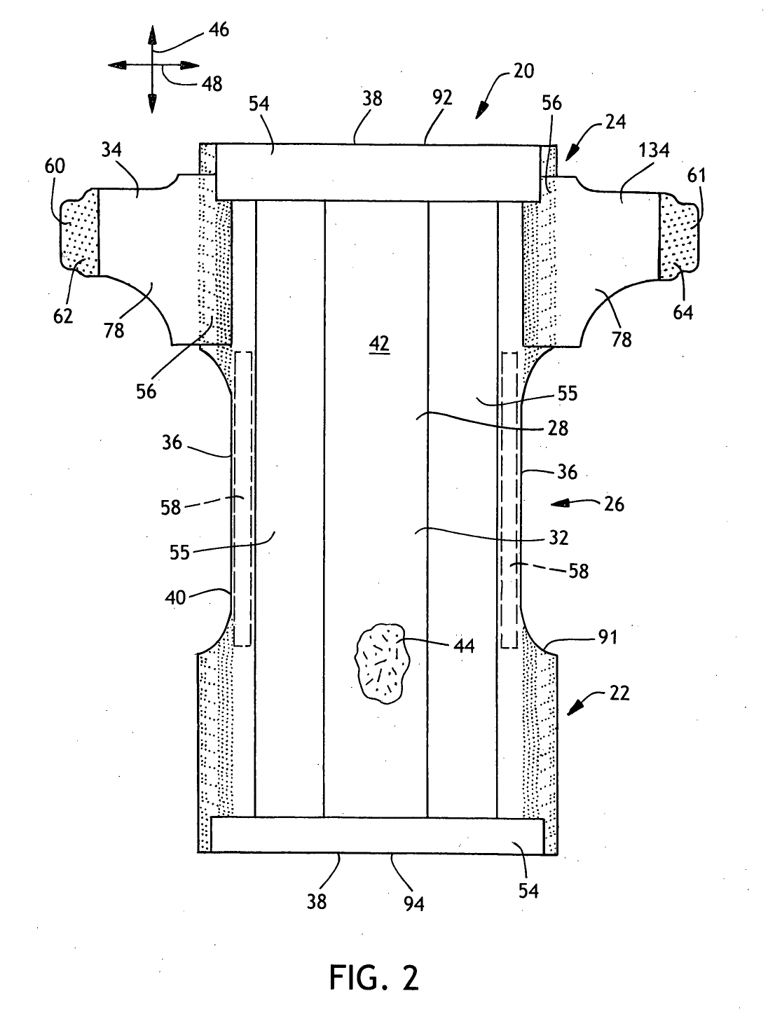

The diaper 20 is illustrated in FIG. 1 in a fastened condition. The diaper 20 defines a longitudinal direction 46 and a lateral direction 48 perpendicular to the longitudinal direction as shown in FIG. 2. The diaper 20 further defines a pair of longitudinal end regions, otherwise referred to herein as a front waist region 22 and a back waist region 24, and a center region, otherwise referred to herein as a crotch region 26, extending longitudinally between and interconnecting the front and back waist regions 22, 24. The front and back waist regions 22, 24 includes those portions of the diaper 20, which when worn, wholly or partially cover or encircle the waist or mid-lower torso of the wearer. The crotch region 26 generally is that portion of the diaper 20 which, when worn, is positioned between the legs of the wearer and covers the lower torso and crotch of the wearer. The diaper 20 also defines an inner surface 28 adapted in use to be disposed toward the wearer, and an outer surface 30 opposite the inner surface. With additional reference to FIG. 2, the diaper 20 has a pair of opposed article side edges 36 extending in the longitudinal direction 46 and a pair of opposed article waist edges 38 extending in the lateral direction 48, referred to herein as the article back waist edge and the article front waist edge.

The illustrated diaper 20 can include an absorbent chassis, generally indicated at 32. The absorbent chassis 32 can define a first chassis side edge 90 extending in the longitudinal direction 46 and a second chassis side edge 91 extending in the longitudinal direction 46, opposite the first chassis side edge 90. The absorbent chassis 32 can also define a pair of longitudinally opposite chassis waist edges referred to herein as the chassis back waist edge 92 and the chassis front waist edge 94.

For example, in the aspect of FIG. 1, the diaper 20 includes an absorbent chassis 32 and a first ear 34 formed separately from and attached to the absorbent chassis 32 proximate the first chassis side edge 90. The diaper 20 also can include a second ear 134 formed separately from and attached to the absorbent chassis 32 proximate the second chassis side edge 91. The ears 34, 134 can be attached along seams 56 proximate the chassis side edges 90, 91 in either the front waist region 22 or in the back waist region 24 of the diaper 20. In the illustrated aspects, the ears 34 and 134 are attached in the back waist region 24. The ears 34 and 134 may be attached to the absorbent chassis 32 using means known to those skilled in the art such as adhesive, thermal bonding, pressure bonding, ultrasonic bonding, and the like or combinations thereof.

The absorbent chassis 32 is illustrated in FIG. 2 as being substantially I-shaped. However, it is contemplated that the absorbent chassis 32 may have other shapes (e.g., hourglass, T-shaped, rectangular, and the like).

The absorbent chassis 32 can include an outercover 40 and a bodyside liner 42 (FIGS. 2) in a superposed relation therewith. The liner 42 can be suitably joined to the outercover 40 along at least a portion of the absorbent chassis 32. The liner 42 can be suitably adapted, i.e., positioned relative to the other components of the diaper 20, to contact the wearer's skin during wear of the diaper. The absorbent chassis 32 also includes an absorbent body 44 (FIG. 2) disposed on the inner surface of the article relative to the outercover 40 for absorbing liquid body exudates. For example, the absorbent body 44 can be located between the outercover 40 and the bodyside liner 42. The liner 42 can be coextensive with the outercover 40 or can be larger or smaller than the outercover 40.

The diaper 20 can optionally include a pair of containment flaps 55 for inhibiting the lateral flow of body exudates. The containment flaps 55 can be operatively attached to the diaper 20 in any suitable manner as is well known in the art. In particular, suitable constructions and arrangements for the containment flaps are generally well known to those skilled in the art and are described in U.S. Pat. No. 4,704,116 issued Nov. 3, 1987 to Enloe, which is incorporated herein by reference to the extent that it is consistent (i.e., not in conflict) herewith.

To further enhance containment and/or absorption of body exudates, the diaper 20 may optionally include waist elastic members 54 in the front and/or back waist regions 22 and 24 of the diaper 20. Likewise, the diaper 20 may optionally include leg elastic members 58, as are known to those skilled in the art. The waist elastic members 54 and the leg elastic members 58 can be formed of any suitable elastic material that is well known to those skilled in the art. For example, suitable elastic materials include sheets, strands or ribbons of natural rubber, synthetic rubber, or thermoplastic elastomeric polymers.

The outercover 40 may suitably include a material that is substantially liquid impermeable. The outercover 40 may be provided by a single layer of liquid impermeable material, or more suitably include a multi-layered laminate structure in which at least one of the layers is liquid impermeable. In particular aspects, the outer layer may suitably provide a relatively cloth-like texture to the wearer. Alternatively, the outercover 40 may include a woven or non-woven fibrous web layer that has been totally or partially constructed or treated to impart the desired levels of liquid impermeability to selected regions that are adjacent or proximate the absorbent body. The outercover 40 may also be stretchable, and in some aspects it may be elastomeric.

The bodyside liner 42 is suitably compliant, soft-feeling, and non-irritating to the wearer's skin. The bodyside liner 42 is also sufficiently liquid permeable to permit liquid body exudates to readily penetrate through its thickness to the absorbent body 44. Alternatively, the bodyside liner 42 may also be stretchable, and in some aspects it may be elastomeric.

The absorbent body 44 can be in a variety of shapes and configurations as are known in the art, such as rectangular, hourglass shaped, I-shaped, and the like. In one aspect, the absorbent body 44 may be stretchable so as not to inhibit the stretchability of other components to which the absorbent body may be adhered, such as the outercover 40 and/or the bodyside liner 42. For example, the absorbent body may include materials disclosed in U.S. Pat. Nos. 5,964,743, 5,645,542, 6,231,557, 6,362,389, and international patent application WO 03/051254, the disclosure of each of which is incorporated by reference herein.

In some aspects, a surge management layer (not shown) may be included in the diaper 20. The surge management layer may be positioned in the diaper 20 in a variety of locations as is known in the art. For example, the surge management layer can be proximate the absorbent body 44, for example between the absorbent body 44 and the bodyside liner 42, and attached to one or more components of the diaper 20 by methods known in the art, such as by adhesive, ultrasonic bonding, pressure bonding, thermal bonding, and the like or combinations thereof. Examples of suitable surge management layers are described in U.S. Pat. No. 5,486,166 and U.S. Pat. No. 5,490,846, the contents of which are incorporated herein by reference to the extent that they are consistent (i.e., not in conflict) herewith.

As mentioned above, the various aspects of the diaper 20 of the present invention can also include a first ear 34 and optionally a second ear 134 (FIGS. 1-2). The first and second ears 34 and 134 may be joined to the absorbent chassis 32 on the inner surface 28 of the diaper 20 (FIGS. 1-2), the outer surface 30 of the diaper 20, or can be sandwiched between at least some of the layers that can make up the absorbent chassis 32, such as the outercover 40 and liner 42. Moreover, the first and second ears 34, 134 may be attached in various combinations. For example, the first ear 34 can be joined to the absorbent chassis 32 on the inner surface 28 of the diaper 20 while the second ear 134 can be joined to the absorbent chassis 32 on the outer surface 30 of the diaper 20.

The ears 34 and 134 can be of various shapes and designs as are known in the art. For example, the ears 34 and 134 can be rectangular, triangular, or have complementary shapes such that they may be removed from a single web of material with little or no trim waste. Suitable ear configurations are described in the previously incorporated U.S. Pat. No. 5,496,298 issued Mar. 5, 1996, to Kuepper et al.; and in U.S. patent application Ser. No. 11/116654, entitled ABSORBENT ARTICLE HAVING FRONT AND BACK EARS filed in the name of Van Dyke, the disclosure of which is hereby incorporated by reference to the extent that it is consistent (i.e., not in conflict) herewith.

The ears 34 and 134 of the present invention can include and/or be formed from a base material 78 (FIGS. 1-2). The base material 78 may be provided by materials as are known in the art such as woven materials, nonwoven materials, or combinations thereof. In a particular aspect, at least a portion of the base material 78 is an elastomeric material capable of elongating in at least the lateral direction 48 to provide elastomeric ears 34 and 134. As is known in the art, the base material 78 can optionally include nonstretchable materials or stretchable but inelastic materials. Alternatively, the base materials 78 can include film materials that could also be suitable for use in connection with the outercover 40. In yet another alternative, the base material 78 can include combinations of various stretchable materials and/or nonstretchable materials.

As representatively illustrated in FIGS. 1-2, the first ear 34 can optionally include a first fastening member 60 disposed on the first ear 34. Likewise, the second ear 134 can optionally include a second fastening member 61 disposed on the second ear 134. The fastening members 60 and 61 can be disposed on the base material 78 of the ears 34 and 134 or the fastening members 60 and 61 can be in the form of a separate tab that extends from the base material 78 of the ears 34 and 134.

The first fastening member 60 can define a first active fastening portion 62. Likewise the second fastening member 61 can also define a second active fastening portion 64. As can be readily appreciated, the active fastening portions 62 and 64 can be all or a substantial portion of their respective fastening member 60 and 61. Alternatively, the active fastening portions 62 and 64 can optionally be only a segment of their respective fastening member 60 and 61.

The fastening members 60, 61 may be arranged on the ears 34, 134 to engage different portions of the diaper 20. For example, the fastening members 60, 61 can be configured to engage the outer surface 30 of the diaper 20. In such a configuration, the fastening members 60, 61 can be attached to the ears 34, 134 on the inner surface 28 of the diaper 20. Alternatively, the fastening members 60, 61 attached to the ears 34, 134 can be configured to engage the inner surface 28 of the diaper 20. In such a configuration, the fastening members 60, 61 can be attached to the ears 34, 134 on the outer surface 30 of the diaper 20.

As mentioned, diaper 20 is only one of many diaper configurations. Other broad categories of diapers include training pants, incontinence garments and pads, swim pants, and the like. Other patents including descriptions of such products are incorporated herein to the extent that they are not in conflict with the present invention: U.S. Pat. No. 11/413474, filed Apr. 28, 2006, to Coulter et al.

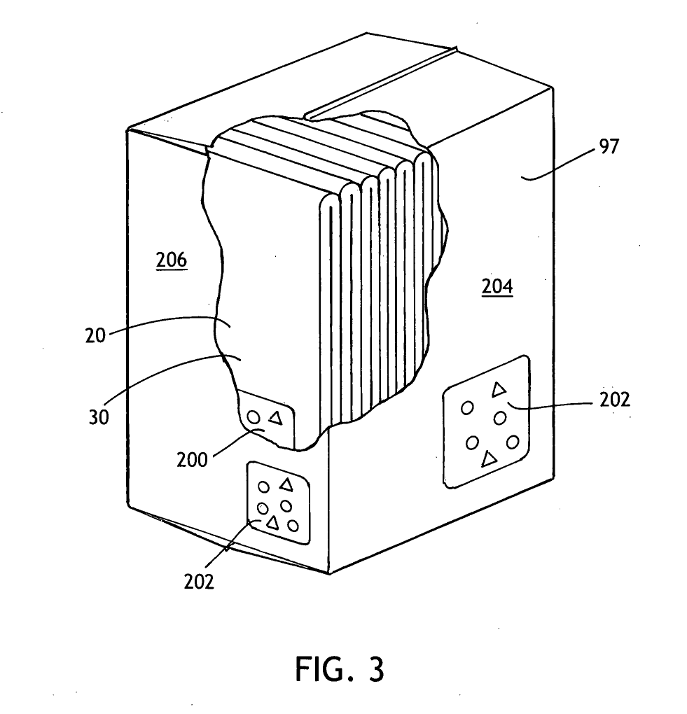

Referring now to FIG. 3, a package of diapers 20 is presented for sale in accordance with the marketing method of the present invention. Because there are so many possible combinations of marketing vehicles possible under the present invention, the showing of just one combination is not meant to be limiting in scope. Each diaper 20 includes a motion-picture-related graphic 200 disposed directly onto the outer cover 30. In particular, the movie-related graphic is printed on the outer cover 30. The graphic may be a character, scene, and/or object from the motion picture; text referring to the motion picture; or a combination thereof. The same or different motion-picture-related graphic 202 may be disposed directly on the outer surfaces of package 97. Of course, the graphics 202 may vary at different locations of the package 97; the front surface 204 may bear a graphic 202 that is different from the graphic 202 located on the side surface 206. In total, this particular example has two degrees of marketing effect. A first marketing effect is due to the array of diapers, which are primary marketing vehicles. The second marketing effect is due to the package 97, a tertiary marketing vehicle.

It is noted from the example shown in FIG. 3 that a plurality of primary marketing vehicles that are identical in structure count as a single marketing vehicle. Therefore, even if each diaper 20, identical in structure, had a different motion-picture related graphic from a single motion picture; as a whole, they operate as a single marketing vehicle. The same rule is not true for secondary or tertiary marketing vehicles. For example, if two identical packages 97 containing identical diaper 20 arrays are sold bundled together with a single outer wrap (not shown), another tertiary marketing vehicle, the result would be a triple marketing effect. The diapers 20 count as a first marketing effect, the identical packages 97 are a second marketing effect, and the outer wrap would be a third marketing effect. In contrast, if two different packages 97 (differing motion-picture related graphics 202 between the two packages 97) are sold bundled together with a single outer wrap, another tertiary marketing vehicle, the result would be a quadruple marketing effect. The diapers count as a first marketing effect, the different packages 97 are a second and third marketing effect, and the outer wrap would be a fourth marketing effect.

The foregoing description of the embodiments of the invention have been presented for purposes of illustration and description. It is not intended to be exhaustive or to limit the invention to the precise form disclosed. Modifications or variations are possible and contemplated in light of the above teachings by those skilled in the art, and the embodiments discussed were chosen and described in order to best illustrate the principles of the invention and its practical application. It is intended that the scope of the invention be defined by the claims appended hereto.

We claim:

1. A marketing method comprising the steps of:
identifying a motion-picture having a future release date;
disposing a motion-picture identifier that identifies the motion picture directly on a disposable health and hygiene article to create a first marketing vehicle; and
combining the first marketing vehicle with a second marketing vehicle to create a promotional vehicle;
offering the promotional vehicle for sale prior to the motion-picture release date.

2. The marketing method of claim 1 further comprising the step of combining a third marketing vehicle with the promotional vehicle.

3. The marketing method of claim 2 further comprising the step of combining a fourth marketing vehicle with the promotional vehicle.

4. The marketing method of claim 3 further comprising the step of combining a fifth marketing vehicle with the promotional vehicle.

5. The marketing method of claim 4 further comprising the step of combining a sixth marketing vehicle with the promotional vehicle.

6. The marketing method of claim 5 wherein the primary marketing vehicle comprises a disposable absorbent article.

7. The marketing method of claim 5 wherein the primary marketing vehicle comprises a sensor.

8. The marketing method of claim 5 wherein the primary marketing vehicle comprises a mitt.

9. The marketing method of claim 5 wherein the primary marketing vehicle is selected from the group consisting of: wet wipes, sheets, and disposable clothing.

10. The marketing method of claim 5 wherein the primary marketing vehicle is selected from the group consisting of: toilet paper, napkins, paper towels, and facial tissue.

11. The marketing method of claim 1 wherein the second marketing vehicle is a tertiary marketing vehicle.

12. The marketing method of claim 1 wherein the second marketing vehicle is a secondary marketing vehicle.

13. The marketing method of claim 12 wherein the secondary marketing vehicle comprises a toy.

14. The marketing method of claim 12 wherein the secondary marketing vehicle comprises a redeemable coupon.

15. The marketing method of claim 12 wherein the secondary marketing vehicle comprises a toiletry dispenser.

16. The marketing method of claim 12 wherein the secondary marketing vehicle is selected from the group consisting of: audio file and movie trailer.

17. The marketing method of claim 12 wherein the secondary marketing vehicle is selected from the group consisting of durable packaging and durable clothing.

18. The marketing method of claim 1 wherein the promotional vehicle is offered for sale at least 1 week prior to the release date of the motion picture.

19. The marketing method of claim 1 wherein the promotional vehicle is offered for sale at least 1 month prior to the release date of the motion picture.

20. The marketing method of claim 1 wherein the promotional vehicle is offered for sale at least 5 months prior to the release date of the motion picture.

21. A marketing method comprising the steps of:
identifying a motion-picture having a future release date;
disposing a motion-picture identifier that identifies the motion picture directly on a disposable absorbent article to create a first marketing vehicle;
combining the first marketing vehicle with a second marketing vehicle to create a promotional vehicle;
offering the promotional vehicle for sale at least 1 month prior to the motion-picture release date.

22. The marketing method of claim 21 further comprising a third marketing vehicle.

23. A marketing method comprising:
identifying a motion-picture having a release date;
disposing a motion-picture identifier that identifies the motion picture directly on a disposable consumer product to create a promotional vehicle; and
offering the promotional vehicle for sale prior to the release date;
wherein the promotional vehicle has at least two degrees of marketing effect.

24. The marketing method of claim 23 wherein the promotional vehicle has at least four degrees of marketing effect.

25. The marketing method of claim 23 wherein the promotional vehicle has at least six degrees of marketing effect.

26. The marketing method of claim 23 wherein the disposable consumer product is a diaper or training pant.

27. The marketing method of claim 23 wherein the motion-picture identifier is motion-picture-related graphics.
